(19) United States
(12) Patent Application Publication
(10) Pub. No.: US 2006/0196351 A1
(43) Pub. Date: Sep. 7, 2006

(54) Actuator

(76) Inventor: Keun Hyung Yoo, Incheon (KR)

Correspondence Address: IPLA P.A., 3580 WILSHIRE BLVD., 17TH FLOOR, LOS ANGELES, CA, 90010, US

(21) Appl. No.: 10/549,022

(22) PCT Filed: Apr. 3, 2004
(86) PCT No.: PCT/KR04/00779

§ 371 Date: Sep. 15, 2005

(30) Foreign Application Priority Data
Apr. 3, 2003 (KR) 10-2003-0021009

(51) Int. Cl. F15B 11/00

(52) U.S. Cl. 91/536

(57) ABSTRACT

The invention is an actuator with simple means for a manual operation in case of emergencies. The invention is an actuator comprising a cylinder (100) in which the 1^{st} fluid pathway (103) and the 2^{nd} fluid pathway (104) having the different course are formed on the wall (110) of the cylinder (100); pistons (160) positioned in said cylinder (100) the 1^{st} fluid pathway (103) and the 2^{nd} fluid pathway (104); and the power transmission units (120, 130, 140) connected to one side of piston (160), and a pathway (210) is provided in the cylinder (100) to communicate the 1^{st} space (101) with the 2^{nd} space (102) in the cylinder (100), and on one side of the pathway (210) is provided a hole (212(, to cross the pathway (210) through which a valve (220)9 is engaged to open or close the pathway (210).

### FIELD OF THE INVENTION

The present invention relates to an actuator not only with no separate converse device for a manual operation in case of emergencies, but also with simple structure for saving the manufacturing cost.

### BACK GROUND OF THE INVENTION

Generally, the actuator is a device which is coupled to a desired unit and provides a driving part of the unit with a forward or backward force and/or a rotating force generated by the hydraulic or pneumatic source. The actuator according to the present invention may be applied to both hydraulic and pneumatic actuators, but for convenience, all description and explanation will be given for the pneumatic actuator, hereinafter.

FIG. 1 depicts an example of actuator according to the prior art, in which a pneumatic actuator for operating a swivel valve is shown. As seen from the drawing, the actuator comprises a pair of piston 160 positioned at both side of interior of cylinder 100; a rotating axis 140 rotating in either direction by the forward or backward action of piston 160; the first air pathway 103 connecting the space 101 between the pistons 160 to the exterior of cylinder; and the second air pathway 104 connecting the space 102 between the pistons 160 and the corresponding cylinder end wall to the exterior of cylinder, thereby opening and shutting the valve connected to the rotating axis 140, by each forward or backward action of the opposed pistons 160, by means of the direction of the compressed air provided through the first and second air pathways 103,104.

In this actuator, the pneumatic pipe lines 11,12 which supply the cylinder 100 with the compressed air from the external air compressor 10 are provided with the solenoid operated valve 20 for controlling direction of air flow in order to achieve the selective intake or drain of air. For example, if either the first air path 103 or the second air path 104 carries out the air intake, the other carries out the air drain.

Nevertheless, if solenoid operated valve 20 stops operation by power off due to the service interruption of electric power or for the worker's sake, the supporting rod 150 linked to the piston 160 must be operated by manual moving the supporting rod 150 forward or backward in order to move the solenoid operated valve 20 again. However, under such situation, since the solenoid operated valve 20 is placed on the neutral state, the compressed air in the cylinder 100 can hardly be drained and both pistons 160 are neither able to move in any direction.

In order to solve the problem, it has been suggested in the prior art to provide the pneumatic pipe lines 11,12 with a separate converting device 30 having a direction controlled ball valve 31 and communicating path 32, for promoting the manual operation of actuator. That is, in normal operating, the communicating path 32 is shut off by the ball valve 31 of the converting device 30, and the piston 160 is reciprocated by the action of solenoid valve 20. On the other hand, when solenoid operated valve 20 is powered off, the ball valve 31 is operated to be open, and the 1st air pathway 103 and the 2nd air pathway 104 in the actuator are communicated with each other, so that the pressure of compressed air applied on the piston 160 may be eliminated.

Therefore, the separate converting device 30 as being aforementioned is essential for the actuator according to the prior art, and it resultantly increases the complication in the structure of the actuator and causes the increase of manufacturing cost.

### SUMMARY OF THE INVETION

The present invention is provided to solve the aforementioned problems of the prior art, and the object of invention is to provide an actuator not only with no separate converse device for a manual operation for emergencies, but also with simple structure in order to save the manufacturing cost.

According to one aspect of the invention, an actuator is provided which comprising a cylinder 100 in which the 1st fluid pathway 103 and the 2nd fluid pathway 104 having the different course are formed on the wall 110 of the cylinder 100 in order for the working fluid to pass through; one or more piston 160 positioned in said cylinder 100 to divide the interior space into the 1st space 101 communicating with the exterior through the 1st fluid pathway 103 and the 2nd space 102 communicating with the exterior through the 2nd fluid pathway 104, and being moved forward and backward along the length of cylinder 100 by the direction of working fluid supplied through the 1st fluid pathway 103 and the 2nd fluid pathway 104; and the power transmission units 120,130,140 connected to one side of piston 160 and transmitting the driving force of piston 160 to the exterior unit, characterized in that a pathway 210 is provided in the cylinder 100 to communicate the 1st space 101 with the 2nd space 102 in the cylinder 100, and on one side of the pathway 210 is provided a hole 212, to cross the pathway 210 through which a valve 220 is engaged to open or close the pathway 210.

According to another aspect of the invention, the both ends of the pathway 210 communicate directly to the 1st fluid pathway 103 and the 2nd fluid pathway 104.

### BRIEF DESCRIPTION OF DRAWINGS

FIG. 1 shows a longitudinal section view of actuator according to the prior art;

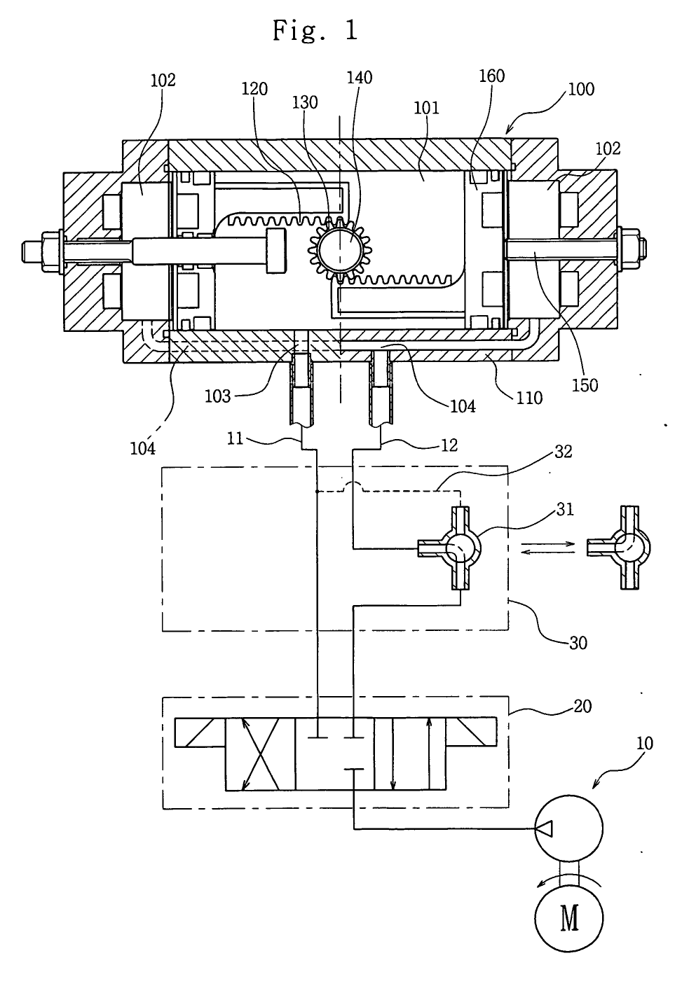

FIG. 2 shows a longitudinal section view of actuator according to a preferable example of the invention; and

FIG. 3 shows a longitudinal section view of actuator according to another example of the invention.

For the reader's reference to the drawings, some reference numbers are given to the important parts of the devices, as follows:

100: cylinder; 101: the 1st space; 102: the 2nd space; 103: the 1st fluid pathway; 104: the 2nd fluid pathway; 120: rack; 130: pinion; 140: rotating axis 140; 160: piston; 210: communicating pathway; 220: screw valve

### BEST MODE FOR EMBODIMENT OF THE INVENTION

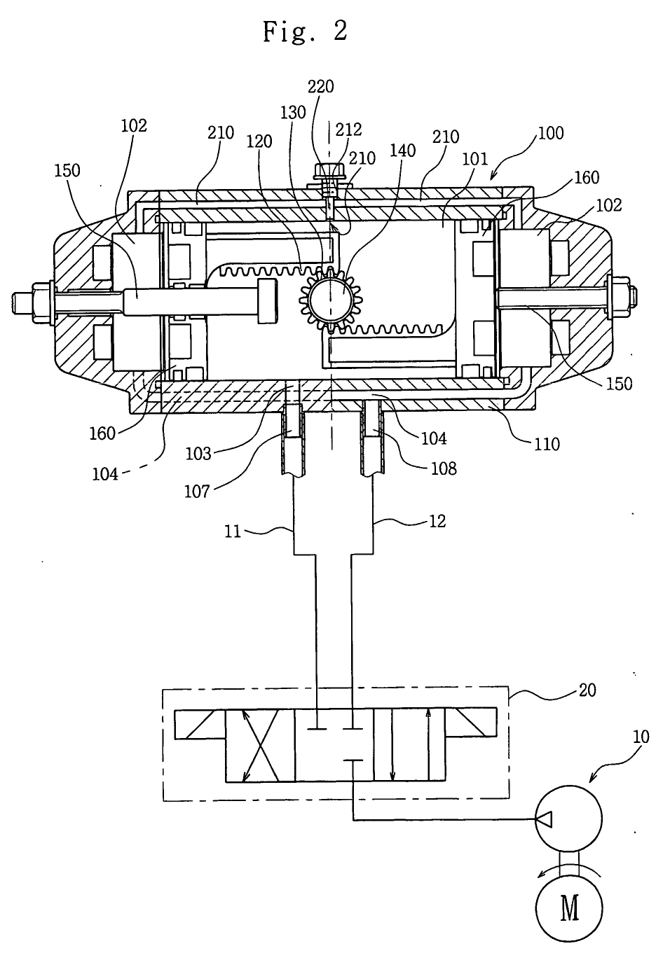

The objects, the features and the advantages of the invention will be described with referring to the drawings. FIG. 2 depicts a longitudinal section view of actuator according to a preferable example of the invention. As seen from FIG. 2, the actuator of the invention comprises a cylinder 100 into which the working fluid is supplied; a pair of pistons 160 positioned on the opposite sides of cylinder 100; a pair of racks 120 extending from the piston 160 and moving reciprocally in the opposite direction each other; a pinion 130 fixed on the rotating axis 140 on the center of the cylinder 100 to be engaged with the rack 120; the pneumatic pipe lines 11,12 connecting the cylinder 100 to the external compressor 10, and a solenoid operated valve 20 placed on the pneumatic pipe lines 11,12 for converting the direction of fluid flow.

According to the preferable example of the invention, the internal space of cylinder 100 is partitioned into an inner space 101 (hereinafter, it will be called as the 1st space) and an outer space 102 (hereinafter, it will be called as the 2nd space), and the 1st fluid pathway 103 and the 2nd fluid pathway 104 are provided in the wall 110 of cylinder 100 respectively. Moreover, two pneumatic pipe lines 11,12 connect a solenoid operated valve 20 to each pathway 103,104 by way of nipples 107,108 so that when the solenoid operated valve 20 is actuating, the compressed air from the air compressor 10 is selectively supplied to either the 1st space or the 2nd space.

Furthermore, on the cylinder wall 110 opposite from the cylinder wall having the 1st fluid pathway 103 and the 2nd fluid pathway 104 is provided a pathway 210 communicating the inner space 101 with the outer space 102. On one side of the pathway 210, is provided a hole 212 being exposed to the exterior, in the direction to cross the pathway 210, and a screw valve 220 is installed in the hole 212 in order to open or close the pathway 210 by the forward movement or backward movement of the screw valve 220.

The pistons 160 are supported by each supporter rod 150 which extends from each cylinder wall 110 along the longitudinal direction. The racks 120 are mounted on the opposing surface of pistons 160 and extend therefrom so that their toothed sides face to each other. Accordingly, once the piston 160 moves forward or backward, the pinion 130 rotates clockwise or counterclockwise, so that the rotating axis 140 transmits the rotating force from the pinion 130 to the external device such as an external valve.

Hereinafter, the action of the actuator according to the invention will be described in details. In normal state, that is, when the electric power is applied, the screw valve 220 is engaged into the pathway 210 and the pathway 210 is blocked. Then, the 1st space 101 and the 2nd space 102 in the cylinder 100 are partitioned to be the separated rooms, and the compressed air is selectively supplied by the action of the solenoid operated valve 20 into the 1st space 101 or the 2nd space 102, thereby effecting an forward or backward movement of the piston 160, by which the pinion 130 engaged with the rack 120 will rotate and resultantly transmit rotating force to the external device. For example, if the rotating axis 140 is connected to a swivel valve installed in the pipe network, the open and close action of the swivel valve can be achieved according to the control signal input to the solenoid operated valve 20, and the degree of openness of the swivel valve can be adjusted as well.

However, if the electric power to the solenoid operated valve 20 is off due to the service interruption of electric power or for the worker's sake, the screw valve 220 may be moved backward to open the pathway 210 in order to communicate the 1st space 101 with the 2nd space 102 in the cylinder 100. Then, the air filled in the 1st space 101 and the 2nd space 102 in the cylinder 100 can flows to each other through the pathway 210. Therefore, the rotating axis 140 can be easily rotated by means of manual operation of pulling or pushing the supporter rod 150 as the air in one space 101,102 can flow to other space 102,101.

According to the present invention, by providing a simple construction in which a pathway 210 is formed in the cylinder wall 110 and a screw valve 220 is installed for opening or closing the said pathway 210, the external device connected to the said rotating axis 140 can readily be operated by manual. It may be an advantage of the invention in terms of saving the manufacturing costs as well as simplifying the structure of actuator with no separate converse device for a manual operation of the prior art, which was complicated and expensive.

In the meantime, a preferable mode is given in the example as being described above only for the easy understanding of invention, in which the cylinder 100 has two pistons 160 and the 2nd space 102 has two rooms on the opposite side of said cylinder 100, as being communicated each other. However, the 1st space 101 and the 2nd space 102 in the cylinder 100 are merely described to explain the direction of inflow or outflow of working fluid, and their positions and numbers may be changed as various as the conventional actuators.

Furthermore, although the rack 120 and pinion 130 are exampled as the means for transmitting the forward or backward force of the pistons 160 to the external driving device, it would be apparent to the ordinary skilled person in the art that the present invention may be applied to the general actuator in which the reciprocal linear movement of the pistons 160 may be transmitted to the external device as it is without conversion or as being conversed into the rotation force.

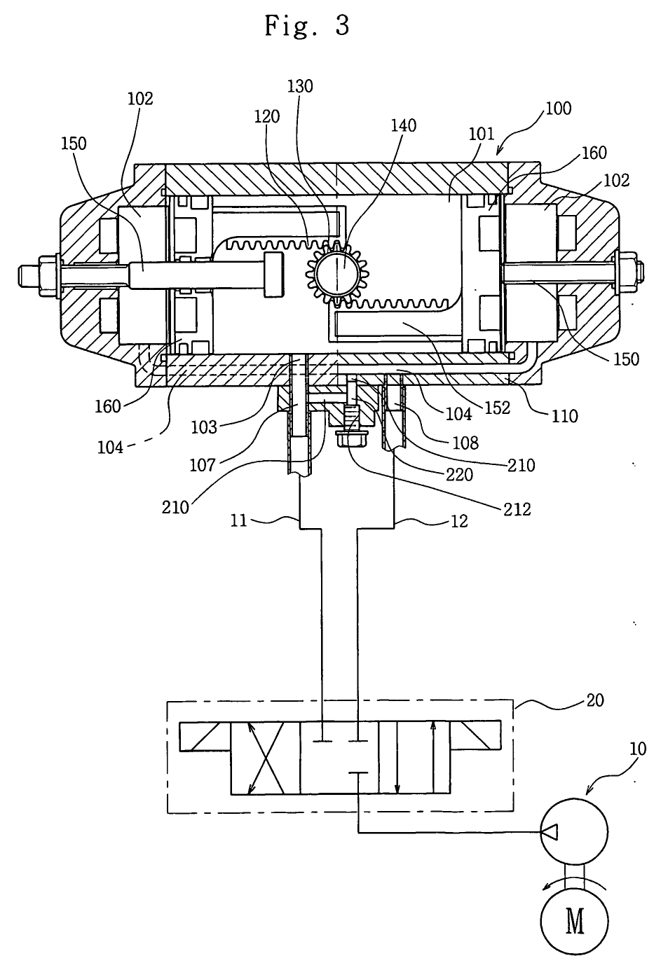

Moreover, the pathway 210 as a means for communicating the 1st space 101 with the 2nd space 102 in the said cylinder 100 may variously be changed in its position and shape other than the examples described as above. In other words, as depicted in FIG. 3 according to another example of the invention, the pathway 210 may be formed to directly connect the 1st fluid pathway 103 and 2nd fluid pathway 104. In this case, the pathway 210 can relatively be shortened, and the further advantage may be obtained for the easier manufacture of cylinder 100.

It is not an intention to limit the present invention as described within the aforementioned examples and the drawings attached hereto, and it would be apparent to the ordinary skilled person in the art to which the invention belongs, that a various alterations, changes and substitutions may be made within the scope and sprit of the invention.

### ADVANTAGEOUS EFFECT

According to the present invention as being described above, an actuator is provided, in which a pathway 210 is formed in the cylinder wall 110, and a screw valve 220 is installed for opening and closing the pathway 210, and which has not only no separate converse device for a manual operation for emergencies, but also the simple structure for significantly saving the manufacturing cost.

1. An actuator comprising a cylinder 100 in which the 1st fluid pathway 103 and the 2nd fluid pathway 104 having the different course are formed on the wall 110 of the cylinder 100 in order for the working fluid to pass through; one or more piston 160 positioned in said cylinder 100 to divide the interior space into the 1st space 101 communicating with the exterior through the 1st fluid pathway 103 and the 2nd space 102 communicating with the exterior through the 2nd fluid pathway 104, and being moved forward and backward along the length of cylinder 100 by the direction of working fluid supplied through the 1st fluid pathway 103 and the 2nd fluid pathway 104; and the power transmission units 120,130,140 connected to one side of piston 160 and transmitting the driving force of piston 160 to the exterior unit, characterized in that a pathway 210 is provided in the cylinder 100 to communicate the 1st space 101 with the 2nd space 102 in the cylinder 100, and on one side of the pathway 210 is provided a hole 212, to cross the pathway 210 through which a valve 220 is engaged to open or close the pathway 210.

2. An actuator of claim 1 wherein, the both ends of the pathway 210 communicate directly to the 1st fluid pathway 103 and the 2nd fluid pathway 104.
